(19) United States
(12) Patent Application Publication
(10) Pub. No.: US 2012/0215849 A1
(43) Pub. Date: Aug. 23, 2012

(54) METHOD AND SYSTEM FOR CONSUMING VIRTUAL MEDIA

(76) Inventors: Ankit Shekhawat, Bangalore (IN); Ramadevi Vennelakanti, Bangalore (IN); Suvodeep Das, Kolkata (IN)

(21) Appl. No.: 13/359,305

(22) Filed: Jan. 26, 2012

(30) Foreign Application Priority Data
Feb. 23, 2011 (IN) 541/CHE/2011

(51) Int. Cl. G06F 15/16

(52) U.S. Cl. 709/204

(57) ABSTRACT

Provided is a method of consuming virtual media. The method allows a user to identify virtual media that the user wants to consume in the presence of at least one other user. The method recognizes co-presence of the user and the at least one other user and recommends the identified virtual media for consumption by the user and the at least one other user.

### BACKGROUND

The desire to share comes naturally to human beings. Whether it is a physical object, such as, a book, a DVD (Digital Video Disc), a piece of cloth, a food item, etc. or a non-physical object, such as, an emotion, knowledge or a past event, most people want to share some aspect of their existence with other individuals. Therefore, it is not uncommon to find people going out together for a walk, to a movie, a theatre or a club house. The basic emotion that underlines these events is to share the experience with another individual.

The Internet has opened new vistas for people to connect with each other. Whether it is an email program, a chat messenger, a blog or a social networking site, individuals have found novel means to connect and share content (for example, videos, music, e-books, etc.) with others. This is typically done by either directly emailing (or file transferring) the content to an individual(s) or by sharing a web link or a bookmark. In both scenarios, the sender and the receiver consume content at different times, thus missing out on the experience and excitement that comes with consuming content together in each other's company or as a group.

### BRIEF DESCRIPTION OF THE DRAWINGS

For a better understanding of the solution, embodiments will now be described, purely by way of example, with reference to the accompanying drawings, in which:

FIG. 1 shows a flow chart of a computer-implemented method of consuming virtual media according to an embodiment.

FIGS. 2A and 2B show a top level view of an implementation of the method of FIG. 1 over a network according to an embodiment.

FIG. 3 shows a block diagram of a user's computing system according to an embodiment.

### DETAILED DESCRIPTION OF THE INVENTION

Computer networks, such as, the Internet, has made it quiet easier for people to connect and share content. Individuals can connect with each other, wherever they may be located, by simply using a computing device and a network connection. The advent of smart phones with their inbuilt wireless capabilities has added a new dimension to quick and affordable communication. People are increasingly using services, such as, push mail, chat, video conferencing, etc to share information and content. It is typical to find individuals sharing media, such as, music, video, photographs, etc. with family, friends, colleagues and acquaintances. Typically, the content is shared through an e-mail program, a chat program, by posting the content to a shared site, by sending a web-link, and the like.

The aforementioned methods of sharing content suffer from many limitations. First, a first user (or consumer) has either no (or very limited) means of knowing a second user's immediate reaction to a particular content. For example, if a user has watched a video clip and subsequently shares it with a friend (by sending it in an email), the user has no way of knowing the friend's reaction (for example, smile, laughter, chuckle, etc.) to the video while it was being watched. The user may ask his/her friend later, but the instant response or reaction which is typically associated when one watches some content might not be received and the user misses out on the experience. Second, there may be a time gap between the consumption of content by a first user and a second user. In this case also, any subsequent interaction and discussion may not provide the experience that is typically associated with co-consumption of content. Third, in a scenario where two or more users get together to consume media that they think the two or more of them will enjoy, any prior consumption of media by one of the users may mar his or her experience of watching it for the second time. This takes away the joy of consuming the media for the first time and sharing the experience.

There are presently no solutions available that enables users (consumers) to collectively consume virtual media that was previously identified by one of the users for consumption in the co-presence of at least one other user, once their co-presence has been recognized by a computing device.

Embodiments of the present solution provide a method and system for consuming virtual media.

For the sake of clarity, the term “virtual media”, in this document, refers to digital data, object or content. By way of example, and not limitation, “virtual media” may include text, audio, video, graphics, animation, images (such as, photographs), multimedia, and the like.

Also, in this document, the term “user” may include a “consumer”, an “individual”, a “person”, or the like.

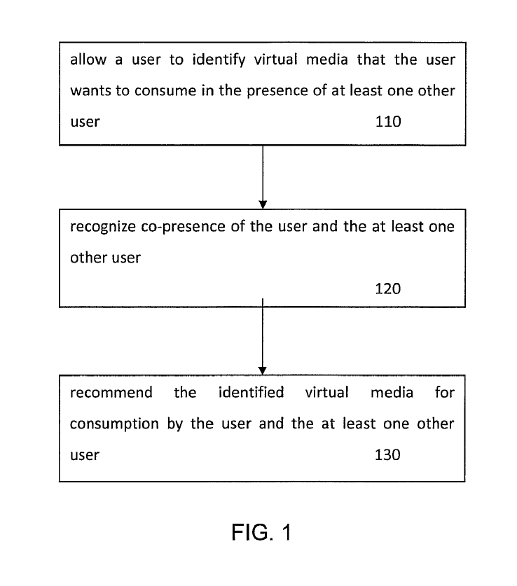

FIG. 1 shows a flow chart of a computer-implemented method of consuming virtual media according to an embodiment.

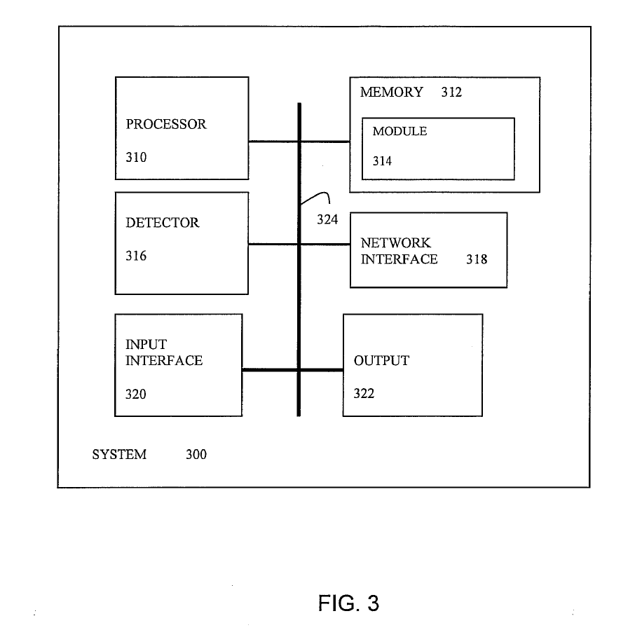

The method may be implemented on a computing device (system), such as, but not limited to, a personal computer, a desktop computer, a laptop computer, a notebook computer, a network computer, a personal digital assistant (PDA), a mobile device, a hand-held device, or the like. A typical computing device that may be used is described further in detail subsequently with reference to FIG. 3.

Additionally, the computing device may be connected to another computing device or a plurality of computing devices via a network, such as, but not limited to, a Local Area Network (LAN), a Wide Area Network, the Internet, or the like. Further, the method may be implemented using a cloud computing architecture.

Referring to FIG. 1, block 110 involves allowing a user to identify virtual media that the user wants to consume in the presence of at least one other user. Using a computing device, such as those mentioned above, a user may identify any virtual media that the user would like to consume in the presence of at least one other user. To illustrate, let's assume that a user is browsing the Internet on his or her computing device. While browsing, the user comes across a video(s) that the user believes would be more enjoyable to watch in the company of another user or a plurality of other users. These other users could be friends, family, colleagues, or an acquaintance of the user. The user could select and store the video(s) that the user would like to consume (view) in the presence of other users. In the present example, the media (video) may be located (hosted) on a computer server and the user may be connected to the computer server through a network, such as the ones mentioned above. Further, the user may perform the identification, selection and storage of the media on the computer server itself. In another instance, the aforementioned steps may be distributed over a plurality of computer servers connected to each other. For example, a user may identify and select the video on one computer server, but the storage of the video may take place on another computer server.

In a further example, the identification, selection and storage of a virtual media may take place on the user's computing device. The user need not be connected to a computer server on a network. To illustrate, let's assume that a user has purchased an audio compact disc (CD) for playing on his or her computing device. Upon playing the CD in a suitable computing device (for example, a laptop), the user may want to consume (listen) some tracks in the presence of another user(s). In such case, the user may identify the tracks and also the other users in whose presence the user would like to enjoy the music. The method allows a user to store the identified virtual media on a storage medium (e.g. the non-removable hard disk on the user's laptop). However, the storage medium may also be of removable type, such as, a pen (thumb) drive, a Compact Disc (CD), and the like.

In another example, after identifying the video(s) that user would like to consume (view) in the presence of other users, the user also has the option to identify and/or select the users with whom the users would like to watch the video(s). A user interface (such as, a Graphical User Interface) with suitable user interface elements (such as, but not limited to, buttons, menus, drop down menus, text fields, a dialog box, and the like) may be provided on the computing device of the user for identification, selection and storage of virtual media (for example, video) that the user wants to consume in the presence of other user(s). The user interface may also allow a user to identify and select the other users with whom the user would like to consume the identified or stored virtual media.

In a yet another example, once a user has identified and stored the virtual media that the user wants to consume in the presence of another user(s), the user may invite another user(s) to add to the collection of stored virtual media. To illustrate, a Person A may first identify and/or store virtual media that he or she wants to consume with Person B. Person A then may inform Person B that the virtual media has been stored at a particular location. Upon information, Person B may add media objects he/she would also to consume in the presence of Person A. The method allows the user and the at least one other user to identify virtual media from separate locations using a computer network. In this example, Person A and Person B may add to the collection of stored virtual media from their own locations. For instance, Person A (who may be located in Office XYZ) and Person B (who may be in Home XYZ) may add to the collection of virtual media (stored on a computer server) from their own respective locations by connecting to the computer server over a network.

A user may store the identified virtual media in a folder or plurality of folders. A user may create a separate folder for each other user or a group of other users. Each folder may contain virtual media that the user wants to consume in the presence of the other user or the group of other users. To illustrate, let's assume that a Person A wants to consume certain virtual media in the presence of a Person B. In this case, Person A may create a folder specifically for Person B, where Person A (and also Person B) may store virtual media that they would like to consume in each other's presence. In another scenario, Person A may want consume some media in the presence of Person B, Person C and Person D. In this case, Person A may create a folder for the group (Person A, Peron B, Person C and Person D). All of them will be able to add virtual media that they would like to consume together as a group.

In another instance, a user may create separate folders for different types of virtual media. To illustrate, a user may create a Folder 1 for videos, a Folder 2 for photographs, a Folder 3 for audio files, a Folder 4 for documents, and so on. For each folder, the user may identify other user(s) in whose presence the user would like to consume the media.

It may be noted that the term “folder” refers to a conceptual container which may contain an aggregation or collection of a group of objects. The term includes a file, a directory, a database, a repository, and the like.

Block 120 involves recognizing co-presence of a user and at least one other user. The method may recognize physical and/or virtual co-presence of a user of a computing device along with other user(s). The recognition of user or a group of users may take place in many ways. In some instances, the recognition of a user(s) may take place automatically when the user(s) is/are in proximity of the computing device. In other cases, an explicit input from a user(s) may be needed. Virtual co-presence of users is also recognized, for example, when it determined that they are online (i.e. on a network) at the same time.

In an example, the physical recognition of a user(s) may take place automatically by a computing device having an imaging device (for example, a camera) and a face detection and recognition module. The imaging device may be removably or non-removably attached to the computing device. The computing device (through an imaging device) automatically detects the presence of a user or group of users when the user or group of users is/are in proximity of the computing device. The imaging device captures an image of a user in proximity of the computing device and passes on the captured image to the face detection and recognition module. The module in turn processes the image for recognition of the user. A pre-existing repository containing a collection of user images may be accessed and referred to for recognition of a user.

In another instance, a computing device may detect a user or group of users by recognizing their voice or speech. In such case, the computing device may include a microphone and a voice recognition module. The computing device automatically detects the presence of a user or group of users when the user or group of users is/are in proximity of the computing device. The microphone captures a voice sample of a user in proximity of the computing device and passes on the captured sample to the voice recognition module. The module in turn processes the sample for recognition of the user. A pre-existing repository containing a collection of voice samples may be accessed and referred to for recognition of a user.

In another example, a biometric input system (by way of non-limiting examples, a fingerprint input system, a gaze recognition system, etc.) along with a biometric recognition module on a computing device may be used to recognize a user(s). In this case, an explicit input from a user(s) may be needed. To illustrate, a thumb recognition system may be present on a system that requires a user to provide a thumb imprint on the computing device. Once a thumb imprint is obtained, it is passed on to a recognition module for processing. A pre-existing repository containing a collection of thumb imprints of users may be accessed and referred to for recognition of a user.

In a further example, proximity of users' computing devices may allow for recognition of physical co-presence of users. To illustrate, let's assume that a User A is using a wireless laptop and a User B is using a wireless mobile device. In this case, if the two devices are in proximity of each other (proximity range may be defined by the technology used to identify proximity of two devices, for example, if Bluetooth is used, the range would be that permissible by Bluetooth technology; if Wi-Fi (Wireless Fidelity) is used, then the proximity range would be as per Wi-Fi technology, and so and so forth), the method would identify the proximity (of devices) as recognition of physical co-presence of users A and user B.

In all above examples, in case there is a plurality of users in proximity of a computing device, the method recognizes those users. For instance, if Person A and Person B are in proximity of a computing device, the method would recognize both of them.

Virtual co-presence of users may be recognized, for example, by recognizing login details (login ID, etc.) of the users.

Block 130 involves recommending the identified virtual media for consumption by a user and at least one other user. Once the co-presence (whether physical, virtual or both) of a user and at least one other user is recognized by a computing device, the method recommends virtual media which was earlier identified by the user for consumption in the presence of at least one other user. In other words, the method automatically recommends virtual media which a user wanted to view in the presence of another user. It recognizes that the users who wanted to consume certain virtual media together are now present in the proximity of a computing device and thereby offers the virtual media which was previously identified for co-consumption by the user(s).

To illustrate, if Person A had identified and/or stored virtual media that Person A wanted to consume in the presence of Person B, the method, upon recognition of the physical co-presence of Person A and Person B, offers virtual media that Person A had identified earlier for consumption of Person A and Person B. The identified virtual media may be a video, an audio file, a document, an e-book, a photo, or the like.

The identified virtual media may be displayed on a display device, such as, but without limitation, on the computing device which recognized the users, a secondary device, a secondary display, a television set, etc.

Once the virtual media is displayed the user(s) could take any action with regards to the media (for example, play, delete, modify, etc.).

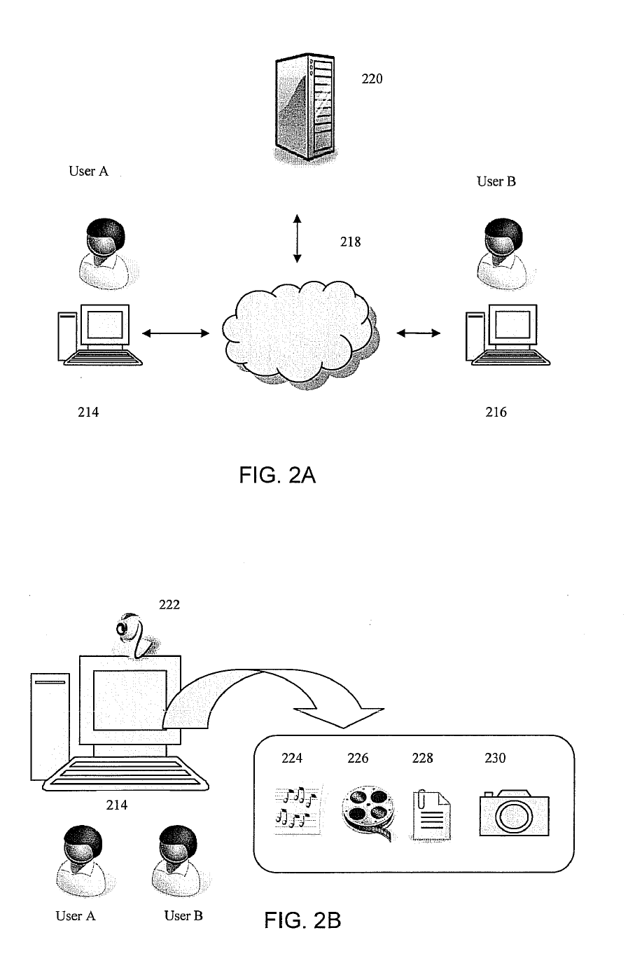

FIGS. 2A and 2B show a top level view of an implementation of the method of FIG. 1 over a network according to an embodiment.

The system 200 of FIG. 2 includes two users, User A with a computing device 214 and User B with a computing device 216. The computing devices 214 and 216 are connected to each other over a network 218.

As mentioned earlier, the method may be implemented on different networks, such as, but not limited to, a Local Area Network (LAN), a Wide Area Network, the Internet, or the like. Further, the network 218 may be a wired or a wireless network.

Also, the computing devices 214 and 216, may be, but not limited to, a personal computer, a desktop computer, a laptop computer, a notebook computer, a network computer, a personal digital assistant (PDA), a mobile device, a hand-held device, or the like. In an instance, the computing devices 214 and 216 may be standalone systems.

System 200 also includes a computer server 212, which may be accessible to computing devices 214 and 216 over network 218. Computer server 212 may be a web server hosting a variety of virtual media, for example, a video site, a music site, an e-books site, etc.

Although only a single computer server 212 and two computing devices 214, 216 have been shown for the purpose of illustration, the system 200 may include a plurality of computer servers and computing devices connected to each other through a network.

Referring to FIG. 2A, User A connects to server 212 through network 210 (for example, the Internet) and identifies virtual media (for example, videos) on server 212 that User A would like to consume in the presence of at least one other user, for example User B. User may store the identified videos on server 212, if it allows such storage or may download the videos on computing device 214. Let's assume that User A has downloaded the videos which User A wants to consume in User B's presence on computing device 214.

User A may also inform User B of the selection and storage of videos on computing device 214, and may, in an instance, allow User B to add to the collection of User A's videos by granting User B access to computing device 214. In another scenario, if server 212 allows storage of identified videos on the server, both User A and User B may identify and store the videos that they would like to consume together. In either case, a collection of videos (virtual media) is identified and stored which User A and User B would like to consume in each other's presence.

Referring to FIG. 2B, the computing device 214 through an imaging device 222 recognizes the physical co-presence of User A and User B. Once the physical co-presence of User A and User B is recognized, the computing device 214 recommends the virtual media (videos) that were stored in computing device 214 for consumption of user A and user B. The videos may be offered and viewed on a display of computing device 214.

Any type of virtual media that was earlier identified may be displayed for co-consumption of User A and User B. For example, the virtual media may be audio files 224, videos 226, documents 228 and/or photographs 230.

In another example, the identified virtual media is used for generating a profile of a user and at least one other user (in this case, User A and User B). The profile is used to recommend further media for consumption of the user and the at least one other user (User A and User B) when they are physically co-present.

FIG. 3 shows a block diagram of a computing system according to an embodiment.

The system 300 may be a computing device, such as, but not limited to, a personal computer, a desktop computer, a laptop computer, a notebook computer, a network computer, a personal digital assistant (PDA), a mobile device, a hand-held device, or the like.

System 300 may include a processor 310, for executing machine readable instructions, a memory 312, for storing machine readable instructions (such as, a module 314), a detector 316, a network interface, an input interface 320 and an output device 322. These components may be coupled together through a system bus 324.

Processor 310 is arranged to execute machine readable instructions. The machine readable instructions may comprise a module for recommending virtual media that was previously identified by a user for consumption in the physical co-presence of the user and at least one other user. Processor 310 may also execute modules related to face recognition of a user, voice recognition of a user and/or biometric recognition of user.

It is clarified that the term “module”, as used herein, means, but is not limited to, a software or hardware component. A module may include, by way of example, components, such as software components, processes, functions, attributes, procedures, drivers, firmware, data, databases, and data structures. The module may reside on a volatile or non-volatile storage medium and configured to interact with a processor of a computer system.

The memory 312 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. The memory 312 may include a module 314. It may also act as a storage medium that stores virtual media identified by a user(s).

Detector 316 is used to recognize physical and/or virtual co-presence of a user and at least one other user. Detector 316 may be an imaging device, a microphone and/or a biometric system along with a corresponding recognition module, i.e. a face recognition module, a voice recognition module and a biometric recognition module. Detector 316 may also be a module for recognizing virtual co-presence of a user and at least one other user. For example, when the user and the at least one other user are online (i.e. present on a computer network at the same time).

Network interface 318 may be a LAN card, or the like. It allows users to connect to a network in order to identify virtual media from separate locations using a computer network.

The input interface 320 may include: an imaging device (for example, a camera), a biometric interface, a mouse, a key pad, a touch pad, a touch screen, a microphone, a gesture recognizer, a speech recognizer, a gaze recognizer and/or a lip movement recognizer. The interface 320 collects input from a user(s).

The output device 322 may include a Virtual Display Unit (VDU) for recommending and displaying virtual media identified by a user(s).

It would be appreciated that the system components depicted in FIG. 3 are for the purpose of illustration only and the actual components may vary depending on the computing system and architecture deployed for implementation of the present solution. The various components described above may be hosted on a single computing system or multiple computer systems, including servers, connected together through suitable means.

The examples described provide a mechanism for individuals (for example, friends) to have an enhanced media sharing experience due to a co-present situation. When individuals are co-present they could straight away enjoy the media they had intended to share together without wasting time in searching for the media.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present solution.

1. A computer-implemented method of consuming virtual media, comprising:
allowing a user to identify virtual media that the user wants to consume in the presence of at least one other user;
recognizing co-presence of the user and the at least one other user; and
recommending the identified virtual media for consumption by the user and the at least one other user.

2. The method according to claim 1, wherein recognizing co-presence of the user and the at least one other user includes recognizing physical and/or virtual co-presence of the user and the at least one other user.

3. The method according to claim 1, further comprising displaying the identified virtual media on a display device for consumption by the user and the at least one other user.

4. The method according to claim 1, further comprising allowing the user and the at least one other user to identify virtual media from separate locations using a computer network.

5. The method according to claim 1, wherein the virtual media that the user wants to consume in the presence of at least one other user is identified on a computer server.

6. The method according to claim 1, further comprising allowing the user to store the identified virtual media on a storage medium, wherein the storage medium is removable or non-removable.

7. The method according to claim 6, wherein the identified virtual media is stored in a folder.

8. The method according to claim 7, wherein the user creates a separate folder for each other user or a group of other users, wherein each folder contains virtual media that the user wants to consume in the presence of the other user or the group of other users.

9. The method according to claim 7, wherein the user creates separate folders for different types of virtual media.

10. The method according to claim 1, wherein the identified virtual media is used for generating a profile of the user and the at least one other user, wherein the profile is used to recommend further media for consumption of the user and the at least one other user when they are physically co-present.

11. A system, comprising:
a detector to recognize co-presence of a user and at least one other user; and
a processor to execute machine readable instructions, the machine readable instructions comprising: a module to recommend virtual media that was previously identified by the user for consumption in the physical co-presence of the user and the at least one other user.

12. A system according to claim 11, further comprising an input interface that allows the user to identify virtual media that the user wants to consume in the presence of the at least one other user.

13. A system according to claim 11, wherein the detector includes at least one of the following:
(a) an imaging device and a face recognition module;
(b) a microphone and a voice recognition module; or
(c) a biometric input system and a biometric recognition module.

14. A system according to claim 11, further comprising an output unit to display the identified media for consumption by the user and the at least one other user.

15. A system according to claim 11, further comprising a storage medium to store the identified media, wherein the storage medium is removable or non-removable.
